(19) United States
(12) Patent Application Publication
(10) Pub. No.: US 2006/0018653 A1
(43) Pub. Date: Jan. 26, 2006

(54) Image capturing apparatus

(76) Inventor: Toshihito Kido, Matsubara-shi (JP)

Correspondence Address: SIDLEY AUSTIN BROWN & WOOD LLP, 717 NORTH HARWOOD, SUITE 3400, DALLAS, TX, 75201, US

(21) Appl. No.: 11/184,605

(22) Filed: Jul. 19, 2005

(30) Foreign Application Priority Data
Jul. 21, 2004 (JP) 2004-213424

(51) Int. Cl. G03B 17/24

(52) U.S. Cl. 396/310

(57) ABSTRACT

An image capturing apparatus having image sensor which obtains an image of an object, detector configured to detect external flash light except flash light by self-emission, determiner configured to determine whether a quantity of external flash light detected by the detector has reached a predetermined threshold value, identifier configured to identify, as a flash image, an image exposed by the external flash light among the images obtained by the image sensor, and recording portion which receives the flash image identified by the identifier to record when the determiner determines that the quantity of external flash light has reached the threshold value.

### CROSS-REFERENCE TO RELATED APPLICATION

This application is based on Japanese Patent Application No. 2004-213424 filed in Japan on Jul. 21, 2004, the entire content of which is hereby incorporated by reference.

### BACKGROUND OF THE INVENTION

1. Field of the Invention

The present invention relates to an image capturing apparatus such as a digital camera and a mobile communication apparatus having a camera function.

2. Description of the Related Art

In recent years, digital cameras have been rapidly spreading, and some digital cameras are provided with a flash function to enable shooting in dark places such as nighttime. Moreover, among mobile communication apparatuses such as mobile telephones, there have been commercialized apparatuses that are provided with a camera function and are also provided with a flash function to similarly enable shooting in dark places by using the camera function.

However, when the flash function is provided in the digital cameras and mobile communication apparatuses, the apparatuses are increased in size (also increased in weight) accordingly, and cost increases. On the other hand, some apparatuses are provided with a high-luminance LED instead of the flash function. However, the light quantity is insufficient compared to the light quantity necessary for flash shooting.

For example, in a case where shooting is performed in the place of a wedding reception, that is, under dimly lit condition, it can be said that when another person performs flash shooting with the firing of the flash, generally, it is frequently a scene that the user himself or herself likes to shoot. In this case, it is needless to say that shooting in dark places (shooting of a favorable image having a sufficient exposure amount) cannot be performed in digital cameras and mobile communication apparatuses having no flash function, and even if the flash function is provided, shooting cannot be performed as well until flash charging is completed, so that a good opportunity to take a picture is missed.

### SUMMARY OF THE INVENTION

A principal object of the present invention is to provide an image capturing apparatus with which a favorable (high-image-quality) shot image having a sufficient exposure amount can be obtained in dark places without the provision of the flash function and consequently, opportunities for shooting can be increased.

Another object of the present invention is to provide an image capturing apparatus with which a favorable (high-image-quality) shot image having a sufficient exposure amount can be obtained in dark places even during flash charging and consequently, opportunities for shooting can be increased.

The above-mentioned objects of the present invention are attained by providing an image capturing apparatus having image sensor which obtains an image of an object, detector configured to detect external flash light except flash light by self-emission, determiner configured to determine whether a quantity of external flash light detected by the detector has reached a predetermined threshold value, identifier configured to identify, as a flash image, an image exposed by the external flash light among the images obtained by the image sensor, and recording portion which receives the flash image identified by the identifier to record when the determiner determines that the quantity of external flash light has reached the threshold value.

According to the image capturing apparatus having the above structure, the external flash light except the flash light by self-emission is detected by the detector and whether the quantity of external flash light detected by the detector has reached the predetermined threshold value is determined by the determiner. Then, the image exposed by the external flash light among the images obtained by the image sensor is identified as the flash image by the identifier, and when the determiner determines that the quantity of external flash light has reached the threshold value, the flash image identified by the identifier is recorded by the recording portion. As described above, since the flash image exposed by the external flash light is recorded (captured as a shot image) in response to the reception of the external flash light having a predetermined quantity, even in the case of an image capturing apparatus having no flash function or even while the flash is being charged although the flash function is provided, a favorable (high-image-quality, beautiful) shot image having a sufficient exposure amount can be obtained in dark places, and consequently, an image capturing apparatus can be provided with which opportunities for shooting can be increased.

With respect to the “self-emission” referred to in the present invention, for example, some image capturing apparatuses have a flash light emitter (flash light source) that is disposed outside the image capturing apparatus as a separate device and emits flash light in synchronism with the operation of the apparatus by use of infrared rays or the like, and the flash light emission in such a case and flash light emission (from the apparatus itself) by the flash light emitter provided in the apparatus are generically called self-emission.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1(a) which is a perspective view showing the appearance of a mobile telephone as an image capturing apparatus according to a first embodiment is a view of the mobile telephone in an opened condition viewed from the front;

FIG. 1(b) which is also a perspective view showing the appearance of the mobile telephone as the image capturing apparatus according to the first embodiment is a view of the mobile telephone in a closed condition viewed obliquely from above;

FIG. 2 is a block diagram showing an example of a camera control system of the mobile telephone shown in FIGS. 1(a) and 1(b);

FIG. 3 is a functional block diagram for explaining the functions of a main controller 30;

FIG. 4 is a view explaining the operation of image data readout from an image sensor in shooting when a metering portion is provided in the mobile telephone shown in FIG. 1 and external flash light is detected based on the metering by the metering portion;

FIG. 5 is a flowchart showing an example of shooting operations in an external flash shooting mode according to the first embodiment;

FIG. 6 is a schematic front view showing the appearance of a digital camera as an image capturing apparatus according to a second embodiment of the present invention;

FIG. 7 is a block diagram showing an example of a camera control system of the digital camera shown in FIG. 6;

FIG. 8 is a functional block diagram for explaining the function of a main controller shown in FIG. 7;

FIG. 9 is a flowchart showing an example of shooting operations in the external flash shooting mode according to the second embodiment of the present invention;

FIGS. 10(a) and 10(b) are perspective views showing the appearance of a mobile telephone as an image capturing apparatus according to a third embodiment of the present invention, FIG. 10(a) being a view of the mobile telephone in an opened condition viewed from the front, FIG. 10(b) being a view of the mobile telephone in a closed condition viewed obliquely from above;

FIG. 11 is a block diagram showing an example of a camera control system of the mobile telephone shown in FIGS. 10(a) and 10(b)

FIG. 12 is a functional block diagram for explaining the function of a main controller shown in FIG. 11;

FIG. 13 is a view for explaining an operation of image data readout from an image sensor in shooting when no metering portion is provided in the mobile telephone shown in FIG. 10 and external flash light is detected based on image data held in a digital processor;

FIG. 14 is a flowchart showing an example of shooting operations in the external flash shooting mode according to the third embodiment;

FIG. 15 is a schematic front view showing the appearance of a digital camera as an image capturing apparatus according to a fourth embodiment of the present invention;

FIG. 16 is a block diagram showing an example of a camera control system of the digital camera shown in FIG. 15;

FIG. 17 is a functional block diagram for explaining the function of a main controller shown in FIG. 16; and

FIG. 18 is a flowchart showing an example of shooting operations in the external flash shooting mode according to the fourth embodiment of the present invention.

### DESCRIPTION OF THE PREFERRED EMBODIMENTS

Hereinafter, embodiments of the present invention will be described with reference to the drawings.

### First Embodiment

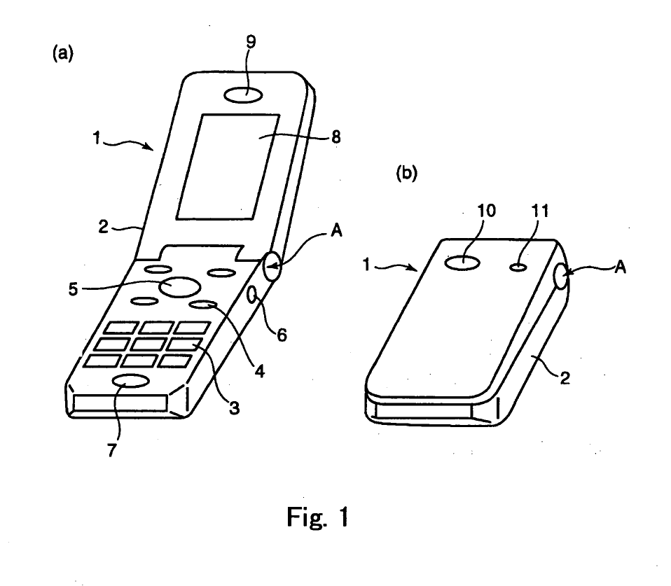

FIGS. 1(a) and 1(b) are perspective views showing the appearance of a mobile telephone as an image capturing apparatus according to a first embodiment of the present invention. FIG. 1(a) is a view of the mobile telephone in an opened condition viewed from the front. FIG. 1(b) is a view of the mobile telephone in a closed condition viewed obliquely from above. As shown in FIGS. 1(a) and 1(b), the mobile telephone 1 has a camera function in addition to a telephone function. On one end (on this side) on the front side of the body 2 or on a side of the body 2, operation buttons such as a key input portion 3, a power switch 4, a mode setting switch 5 and a release switch 6, and a microphone portion 7 are disposed. On the other end on the front side of the body 2, an LCD display 8 comprising a liquid crystal monitor (LCD: liquid crystal display) and a speaker portion 9 for communication are disposed. On the back side, a taking lens portion 10 and a metering portion 11 are disposed. Within the body 2, an image sensor 21 described later that detects the subject brightness and a recording portion 25 or various body devices such as a speaker (not shown) that outputs various sound effects are disposed. The recording portion 25 is disposed so that a recording medium is detachably attachable to the body of the mobile telephone 1. The mobile telephone 1 is structured so as to be foldable (openable and closable), for example, at a substantially central portion designated A of the body 2.

The key input portion 3 is for inputting various letters and characters such as letters of the alphabet (hiragana characters), numeric characters and symbols, and is used for inputting operation instructions, for example, when e-mail or the Internet is used and when the mobile telephone 1 is used as a telephone or a camera. The power switch 4 is a depression switch for turning on (activating) and turning off (deactivating) the power of the apparatus, and is capable of repeating on and off of the power by being depressed. The mode setting switch 5 is a switch for setting various operation modes for the telephone function and the camera function including: a camera mode to perform shooting by use of the camera function provided in the mobile telephone 1; various shooting modes such as an external flash shooting mode to perform shooting by use of external flash light described later in the camera mode: a mode to perform automatic exposure control (AE control) and automatic focusing control (AF control) in the shooting mode; and a mode for the use of e-mail and the Internet.

The release switch 6 is for staring shooting. When the release switch 6 is depressed, shooting (a series of shooting operations to expose the image sensor 21 described later, perform predetermined image processing on the image signal obtained by the exposure and record the image signal onto the recording portion 25) is performed. In the external flash shooting mode, the release switch 6 functions also as a switch for starting an operation associated with shooting using the external flash light. The release switch 6 may be structured so as to be capable of a depression corresponding to AF control. In this case, the release switch 6 is a depression switch capable of, for example, being half depressed into a “half depressed condition” and being further depressed into a “fully depressed condition.” When the release switch 6 is half depressed, preparation operations for shooting an image of the subject (preparation operations such as AE control and AF control) are performed, and when it is fully depressed, the above-mentioned series of shooting operations are performed.

The taking lens portion 10 functions as a lens window capturing light (light image) from the subject and forms a taking lens system (lens unit) for directing the light to the image sensor 21. The metering portion 11, which performs so-called metering outside the apparatus (external metering) to perform metering by measuring the light quantity of the subject, is provided with a predetermined external metering element and measures (detects) the external flash light. The taking lens portion 10 may be provided with a predetermined diaphragm mechanism or shutter mechanism (mechanical shutter) Moreover, in addition to the mode setting switch 5, a switch exclusively used for external flash shooting mode setting may be provided.

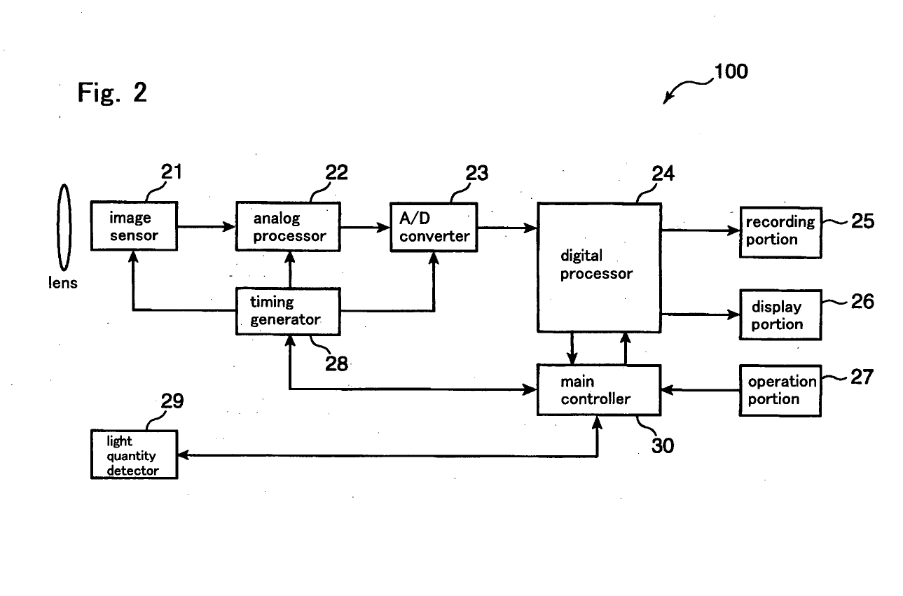

FIG. 2 is a block diagram showing an example of a camera control system of the mobile telephone 1 shown in FIGS. 1(a) and 1(b). As shown in FIG. 2, the camera control system 100 is provided with: the image sensor 21, an analog processor 22, an A/D converter 23, a digital processor 24, the recording portion 25, a display portion 26, an operation portion 27, a timing generator 28, a light quantity detector 29 and a main controller 30. The image sensor 21, which is a so-called area sensor having an image sensor such as a CCD (charge-coupled device), photoelectrically converts the image signal of each of the color components of R, G and B in accordance with the quantity of subject light image formed by the taking lens portion 10 and outputs the image signal.

The analog processor 22 performs predetermined analog signal processings on the image signals outputted from the image sensor 21 (analog image signals read out from the pixels of the image sensor 21) based on a timing pulse from the timing generator 28, and is provided with a CDS circuit (correlated double sampling circuit) that reduces the reset noise included in the analog image signals and an AGC circuit (automatic gain control circuit) that corrects the level (gain) of the analog image signals. The AGC circuit has an amplifier function to compensate for the level insufficiency of the shot image by amplifying the analog image signals at an appropriate amplification factor so as to be suitable for the input voltage range of the A/D converter 23 when appropriate exposure cannot be obtained or the like. For example, the analog processor 22 performs, by use of the AGC circuit, a processing to change the gain so that the image has a brightness suitable for the display on the display portion 26, on the live view image shot in a live view mode described later and a processing to change the gain to a gain suitable for the recording onto the recording portion 25 and the display on the display portion 26, on the captured image shot in a capture mode described later.

The A/D converter 23 converts the analog image signals outputted from the analog processor 22 into digital image signals (digital image data) of, for example, 12 bits. The A/D converter 23 converts the analog image signals into digital image signals based on the clock signal for A/D conversion inputted from the timing generator 28.

The digital processor 24 performs predetermined digital signal processings on the image signals sent out from the image sensor 21, converted into digital data by the A/D converter 23 and inputted. The digital processor 24 performs various image processings such as black reference correction to correct the black level (image signal level under dark condition) of the digital image signals to a reference value, FPN correction to remove FPN (fixed pattern noise) of the image signals, white balance correction to correct the color balance (while balance) of the image signals, color interpolation to interpolate the data of the positions of insufficient pixels of the frame image, gamma correction, and a processing to perform image enlargement and reduction.

The digital processor 24 is also provided with an evaluation value detecting function to detect (calculate) evaluation values used as the base values when AE control, AF control, white balance control (WB control) and the like are performed, that is, an AE evaluation value, an AF evaluation value, a white balance evaluation value (WB evaluation value) and the like, from the image signals shot by the image sensor 21.

The digital processor 24 may be formed so as to be capable of performing the gain changing processings (the processings to change the gain in the live view mode and in the capture mode) described with respect to the analog processor 22, on the image data inputted to the digital processor 24. Moreover, after the digital processing, the digital processor 24 outputs the image data to the display portion 26 and performs a processing to write (record) the image data onto the recording portion 25 and a processing to read out the image data therefrom. The digital processor 24 is provided with an image memory such as a ROM or a RAM for temporarily storing (holding) the image data, for example, having undergone the signal processings.

The recording portion 25 comprises a storage medium such as a memory card or a memory stick, and records (holds), for example, the image data captured from the image sensor 2 and having undergone the predetermined image processings as described above. The recording medium is detachably attachable to the mobile telephone 1 so that the image data can be exchanged, for example, with an external recording device (recording medium).

The display portion 26 comprises the LCD display 8, and performs image display based on the image data for LCD display generated by the digital processor 24. The display portion 26 displays various setting and operation screens associated with the telephone function and the camera function such as an image shot by the image sensor 21 (for example, the live view image when the live view mode is set, and a captured image when the capture mode is set), a reproduced image when an image recorded on the recording portion 25 is reproduced, screens for e-mail and the Internet (character input screens), and a standby screen (wallpaper image). The operation portion 27 comprises various operation buttons such as the key input portion 3 and the release switch 6 (FIG. 1(a)), and outputs a predetermined operation instruction signal to the main controller 30 and the like.

The timing generator (timing generating circuit) 28 generates predetermined timing pulses (timing signals), and controls the shooting operations by the image sensor 21 (charge accumulation based on exposure, charge readout, etc.) and the processing operations of the analog processor 22 and the A/D converter 23. For example, the timing generator 28 generates timing pulses such as a pixel driving signal, a horizontal synchronization signal, a vertical synchronization signal, a horizontal scanning circuit driving signal, a vertical scanning circuit driving signal and the like based on the shooting control signal from the main controller 30, outputs the timing pulses to the image sensor 21, causes charges to be accumulated in response to the exposure operation of the image sensor 21, that is, causes the subject light image to be photoelectrically converted into an image signal, and captures the image from the image sensor 21. Then, the timing generator 28 generates clocks (timing pulses) for analog processing and A/D conversion, outputs them to the analog processor 22 and the A/D converter 23, respectively, and successively outputs the captured image data to the digital processor 24 by way of the analog processor 22 and the A/D converter 23. The light quantity detector 29, which comprises the metering portion 11, measures (detects) the light quantity (brightness) of the subject, and performs so-called external metering.

The main controller 30 comprises a ROM (read only memory) storing various programs such as the control program of the image capturing apparatus, a RAM (random access memory) temporarily storing data and a CPU (central processing unit) reading out the control program or the like from the ROM and executing it, and controls the overall operation of the apparatus. The main controller 30 exchanges data with the digital processor 24, causes the digital processor 24 to perform the signal processings as described above, and performs various computations in response to the signal data from the digital processor 24. Moreover, the main controller 30 performs the driving control of the timing generator 28 based on the instruction signal from the operation portion 27, the detection signal from the light quantity detector 29 and the like. The main controller 30 controls a flash image capturing operation using the external flash light such as performing a predetermined image processing, for example, a processing to reduce the gain (reduce the gain value) on an image shot by the image sensor 21 under the external flash light in response to the detection of the external flash light (hereinafter, this image will be referred to as flash image) and recording the flash image onto the recording portion 25. In addition, the main controller 30 performs various driving controls associated with the functions provided in the apparatus, for example, zooming (zoom) driving and focusing (focus) driving for the lens units of the taking lens portion 10 and the driving control of the diaphragm and the shutter.

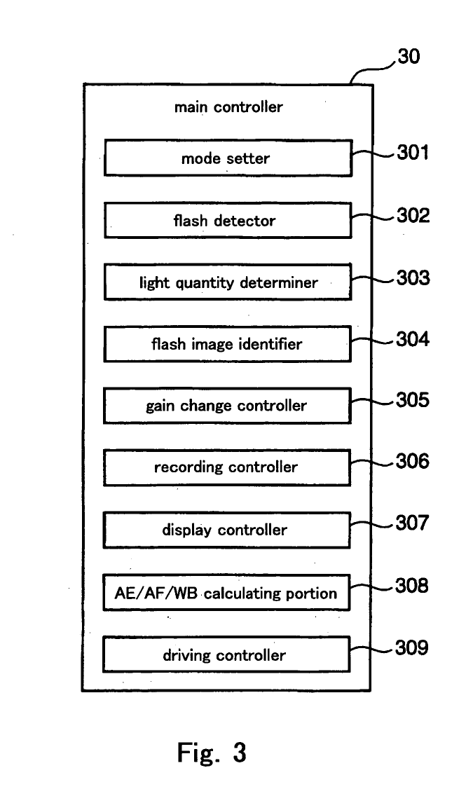

FIG. 3 is a functional block diagram for explaining the functions of the main controller 30. The main controller 30 is provided with a mode setter 301, a flash detector 302, a light quantity determiner 303, a flash image identifier 304, a gain change controller 305, a recording controller 306, a display controller 307, an AE/AF/WB computing portion 308 and a driving controller 309.

The mode setter 301 sets various operation modes such as the camera mode to perform shooting by use of the camera function provided in the mobile telephone 1, the external flash shooting mode to perform shooting by use of the external flash light (or a normal shooting mode when the external flash shooting mode in the camera body is not set), the live view mode and the capture mode. The live view mode is a mode to perform live view readout from the image sensor 21, that is, read out pixels, while thinning them out, from the image shot by the image sensor 21 and perform monitor display (live view display) of the pixel-thinned-out image on the display portion 26. The live view mode in which the pixel-thinned-out image is displayed can be said to be suitable for moving image display at a high frame rate (monitor display in real time). The capture mode is a mode to perform capturing readout from the image sensor 21, that is, read out all the pixels from the shot image and record the image having the all pixel information onto the recording portion 25, and is a mode to perform an image capturing operation for so-called general “shooting”. When each of the above-mentioned modes is set in the mode setter 301, the operation start preparation of each portion of the apparatus is performed in accordance with the mode (for example, in the camera mode, the portions of the apparatus are set in a condition where camera shooting is possible) or the operation in the mode is performed (for example, in the live view mode, live view display is performed on the display portion 26). The images recorded onto the recording portion 25 in the capture mode will be referred to as captured images, and the images displayed on the display portion 26 in the live view mode will be referred to as live view images.

The flash detector 302 detects the external flash light (light quantity). In the present embodiment, the flash detector 302 reads out the signal information from the light quantity detector 29 (based on the detection information) and detects the quantity of external flashlight. The flash detector 302 not only detects the quantity of external flash light but also detects, all the time, the light quantity outside the apparatus inputted from the metering portion 11. The light quantity determiner 303 determines whether the quantity of external flash light detected by the flash detector 302 has reached a predetermined threshold value (or becomes not less than the threshold value) or not. The flash image identifier 304 identifies, as the flash image, the image exposed by the external flash light in the shot image obtained by the image sensor 21.

The gain change controller 305 controls various operations (computations) associated with the change of the gain (amplifier gain) for the shooting image (image data). The gain change controller 305 performs the driving control of the timing generator 28 to thereby cause the analog processor 22 to perform an image processing to change the gain so that the gain for the flash image identified by the flash image identifier 304 is lower than the gain for the image other than the flash image in the shot image when the quantity of external flash light is detected by the flash detector 302 and it is determined by the light quantity determiner 303 that the light quantity has reached the threshold value. With respect to the height (magnitude) of the gain, for example, for shooting under a condition where the brightness of the subject is low, a high gain is set, and when external flash shooting is performed, a gain lower than the above-mentioned gain is set. With this, an image of a subject brightly lit by the external flash light is appropriately reproduced (image quality improves). The gain setting may be performed based on the light quantity information (light quantity integration value) measured by the metering portion 11, and this enables the reproduction of an optimum subject image.

The recording controller 306 performs the control associated with the recording of the shot image onto the recording medium 25. For example, the recording controller 306 causes the digital processor 24 to perform writing and readout of the shot image data onto and from the recording medium 25. The display controller 307 controls the operation associated with the display of the shot image on the display portion 26. For example, the display controller 307 causes the digital processor 24 to generate image data for LCD display, and causes the display portion 26 to display a predetermined image based on the image data.

The AE/AF/WB computing portion 308 computes (calculates) various parameter values associated with the AE/AF/WB control, for example, exposure amount set values such as the aperture area of the diaphragm and the shutter speed, dynamic range set values such as the photoelectric conversion characteristic set value for changing the photoelectric conversion characteristic of the image sensor 21, subject distance information, and the white balance correction value based on the evaluation values detected by the digital processor 24. The calculation of the white balance correction value may be performed by use of information on the color temperature (for example, approximately 5000 to 6000 kelvins) of flash light (self-emission or external flash light).

The driving controller 309 controls the drivers in the image capturing apparatus (in the present embodiment, the mobile telephone 1) in accordance with the parameters calculated by the AE/AF/WB computing portion 308. For example, the driving controller 309 performs the driving control of various actuators for performing zooming driving and focusing driving or diaphragm and shutter driving, or the driving control of the light quantity detector 29. There are cases where the image capturing apparatus (the mobile telephone 1) has no AE or AF function, and in this case, the corresponding parameter calculation and driving control are not performed (this applies to the subsequently described embodiments).

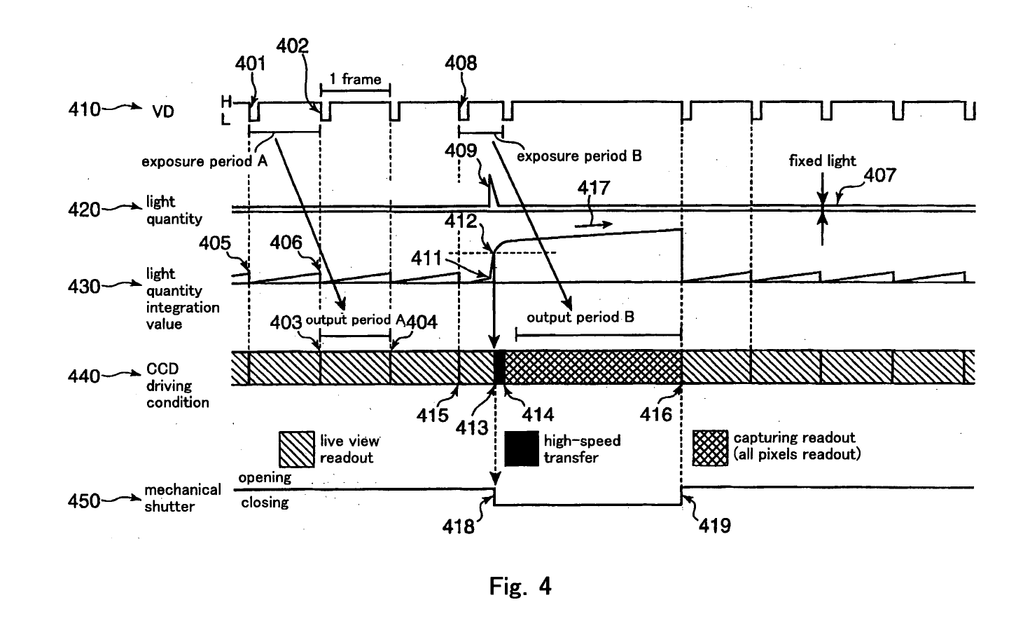

FIG. 4 is a view explaining the operation of image data readout from the image sensor 21 in shooting when a metering portion (the metering portion 11) is provided in the image capturing apparatus (the mobile telephone 1) and external flash light is detected based on the metering by the metering portion. The image data readout operation in the image capturing apparatus having the metering portion is similar in a subsequently-described second embodiment. In FIG. 4, reference numeral 410 represents a vertical synchronization signal (pulse signal) for the image sensor 21 (hereinafter, referred to as VD signal). Reference numeral 420 is a view showing fluctuations in the quantity of light outside (in external environments) the mobile telephone in dark places (hereinafter, the light outside the image capturing apparatus will be referred to as extraneous light). Reference numeral 430 is a view showing fluctuations in the output from the metering portion 11, that is, the light quantity of the subject by the metering by the metering portion 11. Reference numeral 440 is a view explaining the driving condition when image data is read out in the image sensor 21. Reference numeral 450 is a view showing, when a mechanical shutter is provided, the opening and closing operation of the shutter.

At a falling point 401 in a given period when the level of the VD signal becomes from high “H” to low “L,” the exposure of the image sensor 21 (CCD) is started. Then, at the next falling point 402, the readout of the shot image data by the exposure from the image sensor 21 is started, and the next exposure operation is started. In this manner, the exposure and image data readout operations on the image sensor 21 are repeated with the section shown by the falling points 401 and 402 as one period while vertically synchronized by the VD signal. In the figure, the period between the falling points 401 and 402 is designated an exposure period A, and the image data obtained by the exposure in the exposure period A is read out in an output period A between reference numerals 403 and 404 corresponding to the next vertical synchronization period. The above-mentioned one period corresponds to an image of one frame in the shot image captured from the image sensor 21, and the time of the one period is approximately 1/30 second.

As described above, in a predetermined period based on the VD signal (for each frame), live view readout from the image sensor 21 is performed while pixels of the shot image are thinned out. Pixels are thinned out in order to give higher priority to performing the live view display at high speed than to performing the display of the live view image with high resolution. For example, for a shot image of approximately five million pixels, pixels are thinned out by reading out image data, for example, every eight lines in the vertical scanning direction. The image data not read out is reset in the next period (frame).

On the other hand, the VD signal is also synchronized with the metering element of the metering portion 11, and the data of the light quantity integration value with the period shown between reference numerals 405 and 406 corresponding to the period of one frame as one period is outputted from the metering portion 11. The metering portion 11 repeats an operation to reset the light quantity integration value to the initial value every the above-mentioned one period (for example, as shown at the positions of reference numerals 405 and 406). The metering portion 11 resets the light quantity integration value and starts integration concurrently with the start of exposure of the metering element, and reads out the integration value, whereby the exposure amount of the metering element, that is, the quantity of extraneous light can be detected. In dark places, in many cases, a slight quantity of light (weak fixed light), for example, as shown at reference numeral 407 is present (the dark places referred to here indicate, for example, nighttime and dimly lit rooms), and the metering portion 11 detects the fixed light (is exposed by the fixed light) as shown in the view of reference numeral 430 to thereby gradually increase the light quantity integration value with the reset position as the starting point. The light quantity fluctuation of the extraneous light (fixed light) shown at reference numeral 420 is not necessarily fixed as shown in the figure, but the light quantity may fluctuate (in a random fashion). When the light quantity fluctuates like this, it is unnecessary that the change of the light quantity integration value in each period shown at reference numeral 430 be a sawtooth change as shown in the figure, that is, a change such that the value linearly increases in proportion to time in each frame and each has a similar shape.

When the external flash light is emitted at the position shown at reference numeral 409 after the exposure is started at the falling point 408 of the VD signal, the external flash light is measured by the metering portion 11, and based on the measurement information, the external flash light is detected by the flash detector 302. The quantity (light quantity integration value) of external flash light detected in this manner starts to abruptly increase, for example, at reference numeral 411 to reach a predetermined threshold value shown at reference numeral 412, and when the light quantity has reached a level where shooting using the external flash light (external flash shooting) is possible, with the position shown at reference numeral 413 corresponding to the threshold value as the staring point, an operation to read out the flash image exposed by the external flash light is started.

The readout of the flash image obtained by receiving the external flash light is performed, after the mode is switched from the live view mode to the capture mode at the point of time when the threshold value is reached, through capturing readout in the capture mode. In the capturing readout, since all the pixels of the shot image are read out, the output period is an output period B longer than the output period A in the live view readout. As described above, when the period of the VD signal from when the exposure is started at the falling point 408 to when the capturing readout is started at the position shown at reference numeral 414 by receiving the external flash light is the exposure period B (as the actually exposed period, the high speed sweeping period is not included), the image data obtaining a light quantity sufficient for external flash shooting in the exposure period B is output in the output period B.

High-speed sweeping (high-speed transfer) is performed immediately before the capturing readout of the flash image is started (the extremely short period shown at reference numerals 413 and 414). The high-speed sweeping is an operation to discard unnecessary charges (image data) in a transfer portion or the like of the CCD which charges are caused by thermal noise or the like. In the high-speed sweeping, unnecessary charges in the frame immediately before the capturing readout is performed (frame in which live view readout is performed), that is, the period from the exposure start time point shown at reference numeral 415 to the position shown at reference numeral 413 are also swept out. As described above, in the capturing readout, first, unnecessary charges are swept out at high speed, and then, the image data for recording is read out. In contrast to the capturing readout, in the live view readout, unnecessary charges that are necessarily swept out are absent and for this reason, the above-described high-speed sweeping is unnecessary. Therefore, when the readout of the image data for a given frame is finished, the readout of the image data for the next frame is immediately performed. When the capturing readout is finished in the position shown at reference numeral 416, the mode is again switched to the live view mode and the live view readout is started again, so that the live view image is displayed on the display portion 26. Thereafter, when the external flash light is detected, the high-speed sweeping and the capturing readout are performed in the manner described above.

On the image data read out from the image sensor 21 as described above, when the live view readout is performed in the analog processor 22, a processing to correct the gain so that the image has a brightness bearable for the display on the display portion 26, that is, a processing to increase the gain is performed, and when the capturing readout is performed, a processing to correct the gain of the image to prevent overexposure due to the external flash light, that is, a processing to decrease the gain so as to be lower than the gain of the image other than the flash image in the shot image is performed.

As shown at reference numeral 417, the light quantity integration value detected by the metering portion 11 in the capturing readout slightly increases at a constant inclination by further receiving fixed light from the light quantity level obtained by receiving the external flash light shown at reference numeral 409. Moreover, when light interception by a mechanical shutter is necessary after the image sensor 21 is exposed by the external flash light, the shutter may be closed, for example, from the point of time shown at reference numeral 418 corresponding to the position of reference numeral 413 to the point of time of reference numeral 419 corresponding to the position of reference numeral 416. By thus closing the shutter, the generation of smear because of receiving another flash or the like while charges are being transferred in the image sensor 21 (CCD) can be suppressed.

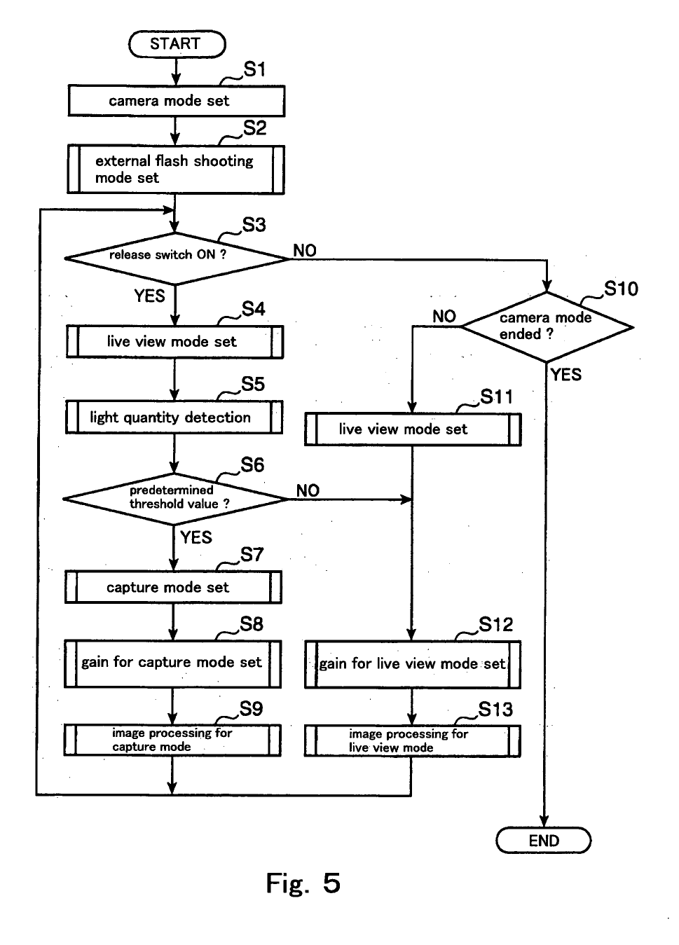

FIG. 5 is a flowchart showing an example of the shooting operations in the external flash shooting mode according to the first embodiment. First, the mode setting switch 5 is operated, so that the camera mode in which shooting is performed by use of the camera function of the mobile telephone 1 is set in the mode setter 301 to bring the mobile telephone 1 in a camera shooting possible condition (step S1) and the external flash shooting mode is set (step S2). When the release switch 6 is not turned on (NO of step S3) and the camera mode set at step S1 is not ended (canceled) (NO of step S10) in the external flash shooting mode, the live view mode is set in the mode setter 301 (step S11), and in accordance with the live view mode, the gain (analog gain) for the live view mode is set in the analog processor 22 based on the timing pulse of the timing generator 28 (step S12). Then, an image processing to change the gain to a gain for the live view mode is performed (other analog processings are also performed) on the live view image (one frame) captured from the image sensor 21, and the live view image is displayed on the LCD display 8 (step S13). When the operation of step S13 is finished, the process returns to step S3, and thereafter, while the release switch 6 is not turned on and the camera mode is not ended, the operations of steps S11, S12 and S13 are repeated to perform live view display. With respect to the setting of the live view mode at step S11, the live view mode may be newly set every time a frame image is read out, or the previous setting of the live view mode may be maintained. When the camera mode set at step S1 is ended (canceled) (YES of step S10), the flow is ended.

When the release switch 6 is turned on at step S3 (YES of step S3), the live view mode is set in the mode setter 301 like in the case of the above-described step S11 (step S4). On the other hand, the light quantity of the subject is measured by the metering portion 11, and the measurement information is outputted to the flash detector 302 and the light quantity is detected (step S5). When the light quantity measurement at step S5 is performed, the light quantity integration value by the metering portion 11 is reset as occasion arises in synchronism with each frame in the condition of the live view mode. When it is not determined by the light quantity determiner 303 that the light quantity detected by the flash detector 302 has reached the predetermined threshold value, that is, when it is determined that the frame image is insufficient in light quantity (NO of step S6), the operations of steps S12 and S13 are performed to perform live view display. That is, even if the release switch 6 is turned on at step S3, when the external flash light has not reached the predetermined light quantity at step S6, the processings of steps S4, S12 and S13 in the live view mode (live view display) is continued.

When it is determined by the light quantity determiner 303 that the quantity of external flash light has reached the predetermined threshold value at step S6 (YES of step S6), the capture mode is set in the mode setter 301 (step S7), and the gain for the capture mode (low gain) is set in the analog processor 22 based on the timing pulse of the timing generator 28 (step S8). Then, the capturing readout of the image data from the image sensor 21 is performed, various image processings such as the change of the gain at the analog processor 22, the white balance correction and color interpolation at the digital processor 24 and the generation of signals for display are performed on the captured image being read out, the captured image is recorded onto the recording portion 25, and the capture mode is ended (step S9). The captured image may be temporarily (not necessarily temporarily) monitor-displayed on the LCD display 8 as well as recorded onto the recording portion 25. When the operation of step S9 is finished, the process returns to step S3. When the external flash shooting mode is not set at step S2, shooting can be performed irrespective of the external flash light. In this case, for example, when the camera mode is set at step S1, the mode is immediately shifted to the live view mode to perform live view display (live view display is not necessarily performed), and then, in response to the turning on of the release switch 6, normal shooting (recording of the shot image) is performed.

### Second Embodiment

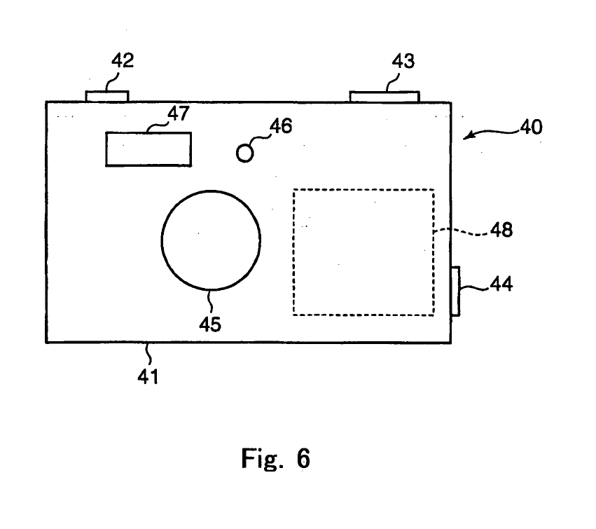

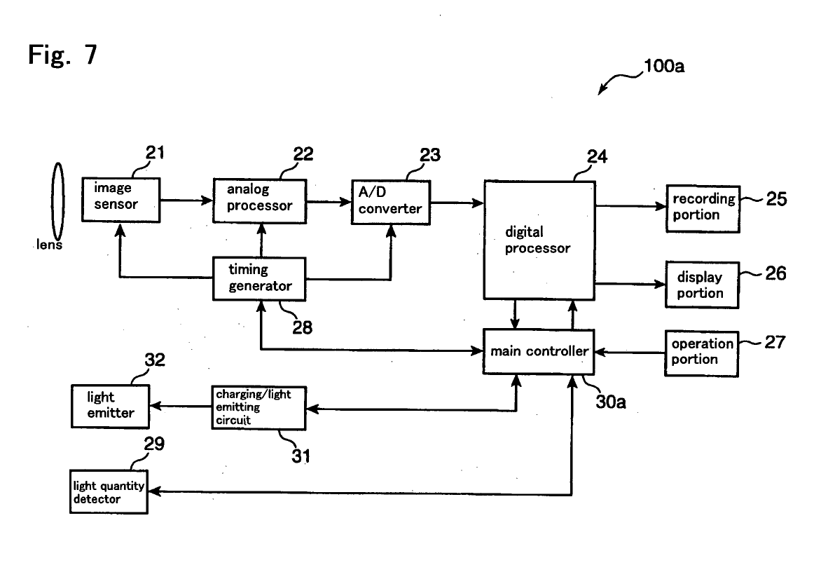

FIG. 6 is a schematic front view showing the appearance of a digital camera as an image capturing apparatus according to a second embodiment of the present invention. As shown in FIG. 6, the digital camera 40 comprises a body 41 having a substantially rectangular parallelepiped external shape. On the top surface and a side surface of the body 41, various operation buttons such as a release switch 42, a mode setting switch 43 and a power switch 44 are disposed, on the front surface, a taking lens portion 45, a metering portion 46, a flash light 47 and the like are disposed, and on the back surface, an LCD display 48 comprising a liquid crystal monitor (LCD) and the like are disposed. Within the body 41, various body devices such as the image sensor 21 and the recording portion 25 shown in FIG. 7 described later and a sound speaker (not shown) that outputs various sound effects such as operation sounds are disposed.

The release switch 42, the power switch 44, the taking lens portion 45, the metering portion 46 and the LCD display 48 of the digital camera 40 are the same as those of the mobile telephone 1 according to the first embodiment, and descriptions thereof are omitted. The mode setting switch 43 is a switch for setting various shooting modes such as the external flash shooting mode to perform shooting using the external flash light except the self-emission of the flash light 47 or the like of the digital camera 40 and the normal shooting mode that is not the external flash shooting mode, and various operation modes such as a mode to perform AE/AF control. The flash light 47 comprises a flash light emitter such as a xenon light, and emits flash light.

FIG. 7 is a block diagram showing an example of a camera control system of the digital camera 40 shown in FIG. 6. The camera control system 100a shown in FIG. 7 is different from the camera control system 100 shown in FIG. 2 in that structures for causing the system to perform flash light emission are provided. These structures will be described below. Other structures are the same as those of the camera control system 100 shown in FIG. 2, and descriptions thereof are omitted. The camera control system 100a is further provided with a charging/light emitting circuit 31 and a light emitter 32 in addition to the structures of the camera control system 100 shown in FIG. 1. The charging/light emitting circuit 31 is a circuit device for performing charging for flash light emission (flash charging) and causing the light emitter 32 to perform flash light emission. The charging condition is detected by the main controller 30. The light emitter 32 comprises the flash light 47, and after the completion of the charging of the charging/light emitting circuit 31, performs flash light emission in response to a flash light emission instruction signal by a depression of the release switch 6 or the like. In the present embodiment, the display portion 26 comprises the LCD display 48, the operation portion 27 comprises operation buttons such as the release switch 42 and the mode setting switch 43, and the light quantity detector 29 comprises the metering portion 46.

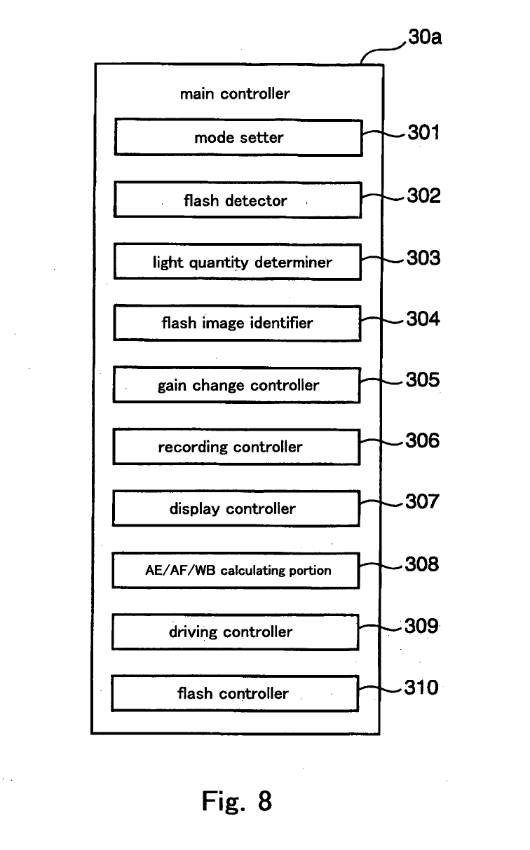

The camera control system 100a has the structures for flash light emission as described above, and accordingly, the main controller 30a is partly different in structure from the main controller 30 shown in FIG. 2. Therefore, the difference will be described. FIG. 8 is a functional block diagram for explaining the function of the main controller 30a. The main controller 30a is further provided with a flash controller 310 in addition to the structures of the main controller 30. The flash controller 310 controls the driving of the charging/light emitting circuit 31 to cause the light emitter 32 to perform flash light emission, and is provided with a charging determination function to determine whether the charging of the charging/light emitting circuit 31 is completed or not, specifically, for example, a piezoelectric monitor that detects the flash charging voltage-by a comparator or the like.

When, for example, a flash mode (a shooting mode to cause the light emitter 32 to perform flash light emission in normal shooting) is set in the mode setter 301, the flash controller 310 starts the charging of the charging/light emitting circuit 31, and after the completion of the charging, causes the light emitter 32 to perform flash light emission by the charging/light emitting circuit 31 in response to a depression of the release switch 42. When the external flash shooting mode is set in the mode setter 301, in a case where the charging is completed when the release switch 42 is depressed, flash light emission is immediately performed, and in a case where the charging is not completed, flash light emission is not performed (even in a case where the charging is not completed, when the external flash light is present, shooting is started by receiving the external flash light). The flash charging in this case may be automatically started at the point of time when the external flash shooting mode is set. The flash controller 310 may be structured so as to control the charging/light emitting circuit 31 so as to be automatically charged to a flash light emission possible level after flash light emission is finished.

Moreover, before flash shooting based on the flash light emission (self-emission) of the light emitter 32 is performed, the flash controller 310 causes the corresponding function portions (for example, the gain change controller 305 and the AE/AF/WB computing portion 308) of the main controller 30a, or the timing generator 28 (the analog processor 22) and the digital processor 24 to perform various settings such as the aperture, the shutter speed (exposure amount; exposure), the white balance correction, the gain correction and the flash light emission amount for the flash shooting to be suitably performed. The amount of flash light emission by the light emitter 32 may be calculated, for example, based on the distance measurement information in the AF function.

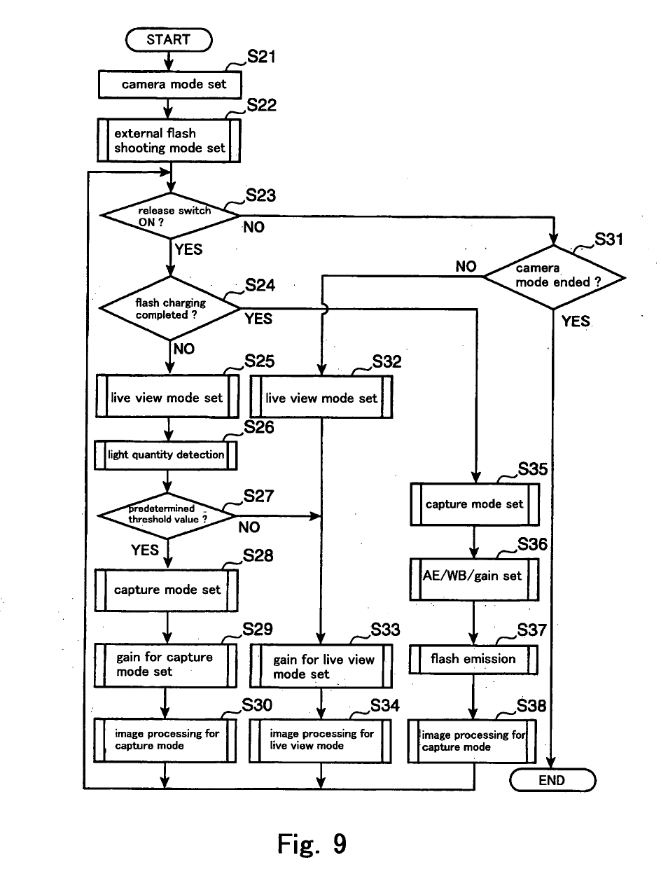

FIG. 9 is a flowchart showing an example of the shooting operations in the external flash shooting mode according to the second embodiment. First, the power switch 44 is turned on to bring the digital camera 40 in a camera shooting possible condition (camera mode) (step S21), and the mode setting switch 43 is operated to set the external flash shooting mode in the mode setter 301 (step S22). When the release switch 42 is not turned on (NO of step S23) and the camera mode set at step S1 is not ended (canceled) (NO of step S31) in the external flash shooting mode, the live view mode is set in the mode setter 301 (step S32), and in accordance with the live view mode, the gain (analog gain) for the live view mode is set in the analog processor 22 based on the timing pulse of the timing generator 28 (step S33). Then, an image processing to change the gain to a gain for the live view mode is performed (other analog processings are also performed) on the live view image (one frame) captured from the image sensor 21, and the live view image is displayed on the LCD display 48 (step S34). When the operation of step S34 is finished, the process returns to step S23, and thereafter, while the release switch 42 is not turned on and the camera mode is not ended, the operations of steps S32, S33 and S34 are repeated to perform live view display. With respect to the setting of the live view mode at step S32, the live view mode may be newly set every time a frame image is read out, or the previous setting of the live view mode may be maintained. When the camera mode set at step S21 is ended (canceled) (YES of step S31), the flow is ended.

In a case where the release switch 42 is turned on at step S23 (YES of step S23), when it is determined that the flash charging is not completed by the flash controller 310 (NO of step S24), the live view mode is set in the mode setter 301 like in the case of the above-described step S32 (step S25). On the other hand, the light quantity of the subject is measured by the metering portion 46, and the measurement information is outputted to the flash detector 302 and the light quantity is detected (step S26). When the light quantity measurement at step S26 is performed, the light quantity integration value by the metering portion 46 is reset as occasion arises in synchronism with each frame in the condition of the live view mode. When it is not determined by the light quantity determiner 303 that the light quantity detected by the flash detector 302 has reached the predetermined threshold value, that is, when it is determined that the frame image is insufficient in light quantity (NO of step S27), the operations of steps S33 and S34 are performed to perform live view display. That is, even if the release switch 42 is turned on at step S23, when the flash charging is not completed at step S24 and the external flash light has not reached the predetermined light quantity at step S27, the processings of steps S25, S26, S33 and S34 in the live view mode (live view display) is continued.

When it is determined by the light quantity determiner 303 that the light quantity has reached the predetermined threshold value at step S27 (YES of step S27), the capture mode is set in the mode setter 301 (step S28), and the gain for the capture mode (low gain) is set in the analog processor 22 based on the timing pulse of the timing generator 28 (step S29). Then, the capturing readout of the image data from the image sensor 21 is performed, various image processings such as the change of the gain at the analog processor 22, the white balance correction and color interpolation at the digital processor 28 and the generation of signals for display are performed on the captured image being read out, the captured image is recorded onto the recording portion 25, and the capture mode is ended (step S30). The captured image may be, for example, temporarily monitor-displayed on the LCD display 48 as well as recorded onto the recording portion 25. When the operation of step S30 is finished, the process returns to step S23.

As described above, since the flow of steps S25 to S30 is provided and shooting can be performed by use of another light source (external flash light) even when the flash charging is not completed, the waiting time of shooting to the completion of the charging (the time lag to shooting) can be reduced. When the external flash shooting mode is not set at step S22, shooting can be performed irrespective of the external flash light. In this case, for example, the following may be performed: The power of the camera is turned on at step S21 to bring the camera in the camera shooting possible condition and then, normal shooting (recording of the shot image) is performed in response to the turning on of the release switch 42, and live view display is performed as appropriate such as performing live view display during a period other than the period during which shooting is performed by the release switch 42 being turned on.

On the other hand, when the flash charging is completed at step S24 (YES of step S24), the capture mode is set in the mode setter 301 like in the case of step S28 (step S35). Then, through the control by the flash controller 310, various settings are made such as the appropriate exposure, white balance and gain corresponding to flash shooting by the light emission (self-emission) of the flash light 47 (step S36). Then, in accordance with the settings, the flash light 47 performs flash light emission not in synchronism with the image (shooting by the VD signal) (step S37), the capturing readout of the image data from the image sensor 21 is performed like at step S30, various image processings are performed on the captured image being read out, and then, the captured image is recorded onto the recording portion 25 and the capture mode is ended (step S38). In this case, the captured image may also be monitor-displayed on the LCD display 48 as well as recorded onto the recording portion 25. When the operation of step S38 is finished, the process returns to step S23. When the external flash shooting mode is not set at step S22, shooting can be performed irrespective of the external flash light. In this case, normal shooting is performed in response to the turning on of the release switch 42 (flash shooting by the light emission of the flash light 47 may be performed). In the normal shooting, live view display may be performed as appropriate.

### Third Embodiment

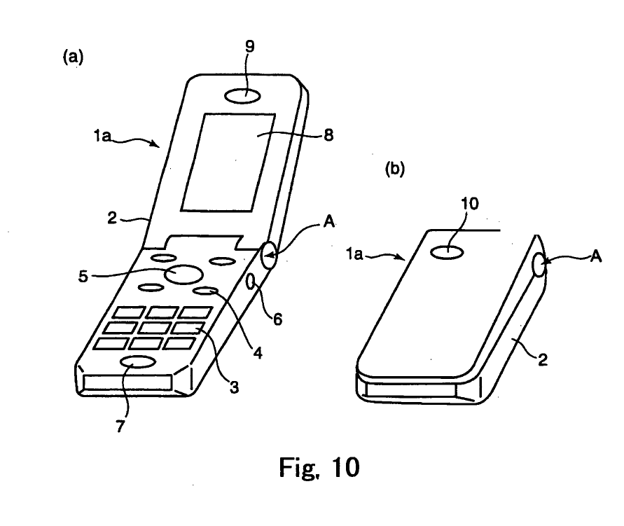

FIGS. 10(a) and 10(b) are perspective views showing the appearance of a mobile telephone as an image capturing apparatus according to a third embodiment of the present invention. FIG. 10(a) is a view of the mobile telephone in an opened condition viewed from the front. FIG. 10(b) is a view of the mobile telephone in a closed condition viewed obliquely from above. The mobile telephone la shown in FIGS. 10(a) and 10(b) is different from the mobile telephone 1 shown in FIG. 1 in that the metering portion 11 (on the back side) is not provided. The structures of other portions are the same as those of the mobile telephone 1 shown in FIG. 1, and descriptions thereof are omitted.

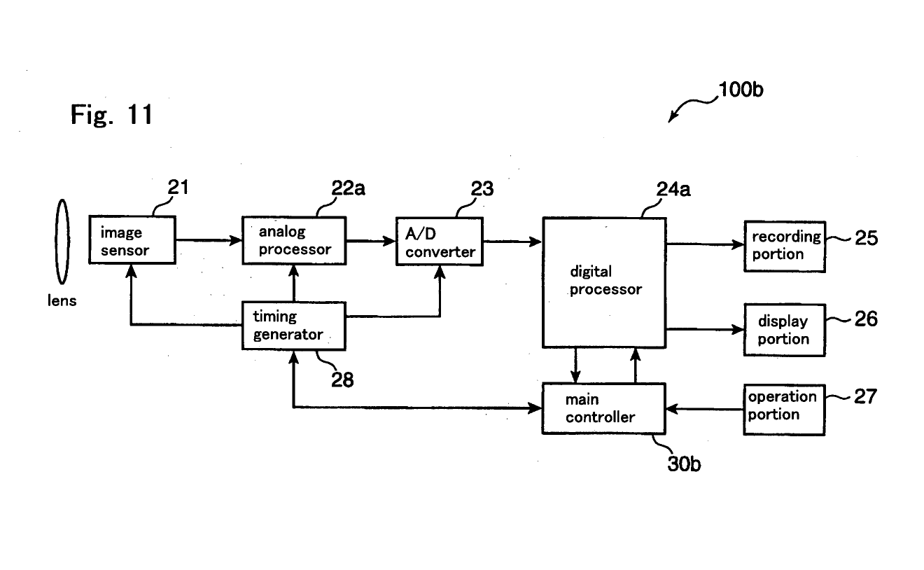

FIG. 11 is a block diagram showing an example of a camera control system of the mobile telephone la shown in FIGS. 10(a) and 10(b). The camera control system 100b shown in FIG. 11 is different from the camera control system 100 shown in FIG. 2 in that the light quantity detector 29 is not provided in the system and that based on the image data captured from the image sensor 21 to a digital processor 24a, the detection of the external flash light, the gain changing processing on the image data and the like are performed. Hereinafter, with respect to the differences, differences in structure between the analog processor 22, the digital processor 24 and the main controller 30 shown in FIG. 2 and an analog processor 22a, the digital processor 24a and a main controller 30b shown in FIG. 11 will be described. Other structures are the same, and descriptions thereof are omitted.

While the analog processor 22a performs predetermined analog signal processings on the image signals outputted from the image sensor 21 based on the timing pulse from the timing generator 28 described later like the analog processor 22, in the present embodiment, in the analog processor 22a, the gain changing processing to adjust the gain to a gain most suitable for performing the live view display on the display portion 26 and the recording onto the recording portion 25 is not performed on the image data such as the live view image shot in the live view mode and the captured image shot in the capture mode. The analog processor 22a may be provided with the above-described AGC circuit (amplifier function) or the like. In this case, a structure may be adopted such that image data is captured from the image sensor 21 with the gain value fixed to a predetermined value (with the gain adjusted so that the gain value is fixed) and the gain-value-fixed image data is outputted to the digital processor 24a. On the other hand, the digital processor 24a performs predetermined digital signal processings on the image signals sent out from the image sensor 21, passing through the analog processor 22a, converted into digital data by the A/D converter 23 and inputted like the digital processor 24. In the present embodiment, the corresponding gain changing processing is performed on the image data inputted to the digital processor 24a (the live view image and the captured image) in the digital processor 24a.

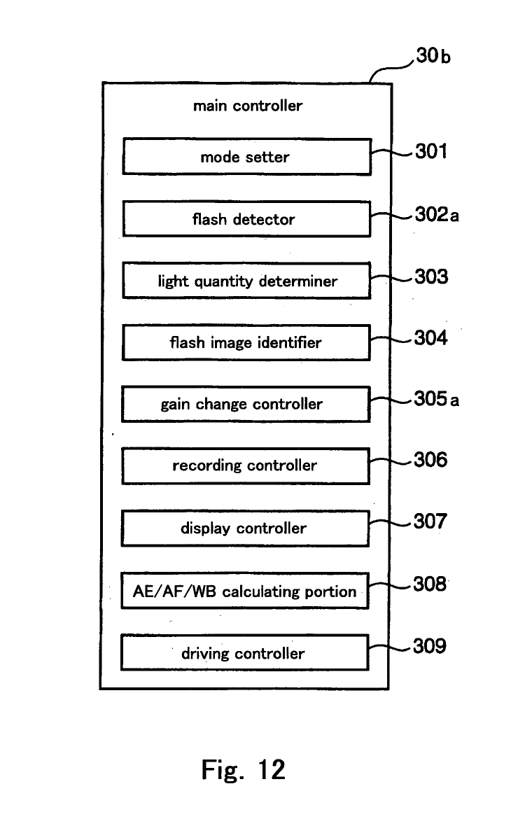

FIG. 12 is a functional block diagram for explaining the function of the main controller 30b. The functional portions of the main controller 30b is different from those of the main controller 30 shown in FIG. 3 in a flash detector 302a and a gain change controller 305a. The flash detector 302a detects the external flash light (light quantity). The flash detector 302a detects the external flash light based on the image data read out from the image sensor 21, passing through the analog processor 22a and the A/D converter 23 and inputted (temporarily stored) to the digital processor 24a. The flash detector 302a not only detects the external flash light but also detects, all the time, the quantity of extraneous light inputted from the image sensor 21 to the digital processor 24a.

The gain change controller 305a controls various operations (computations) associated with the change of the gain (digital gain) for the image data. When the quantity of external flash light is detected by the flash detector 302a and it is determined by the light quantity determiner 303 that the light quantity has reached a threshold value, the gain change controller 305a causes the digital processor 24a to perform an image processing to change the gain so that the gain for the flash image identified by the flash image identifier 304 is lower than the gain for the image other than the flash image in the shot image. With this, an image of a subject brightly lit by the external flash light is appropriately reproduced (image quality improves).

As described above, since the image processing (gain changing processing) on the image data is performed on one that is held in the digital processor 24a as digital data as described above, for example, the following can be performed: The image data read out from the image sensor 21 is captured with the gain, for example, as approximately once (in the analog processor 22a), and then, the gain is freely changed, for example, to twice or three times at a given time, whereby the degree of freedom of image processing increases. This is because although in the analog processor 22a that cannot hold data, the processing such as the gain changing processing can be performed only at the point of time when image data is captured (passes), in the digital processor 24a that can hold data, data can be handled also after the point of time when data is captured.

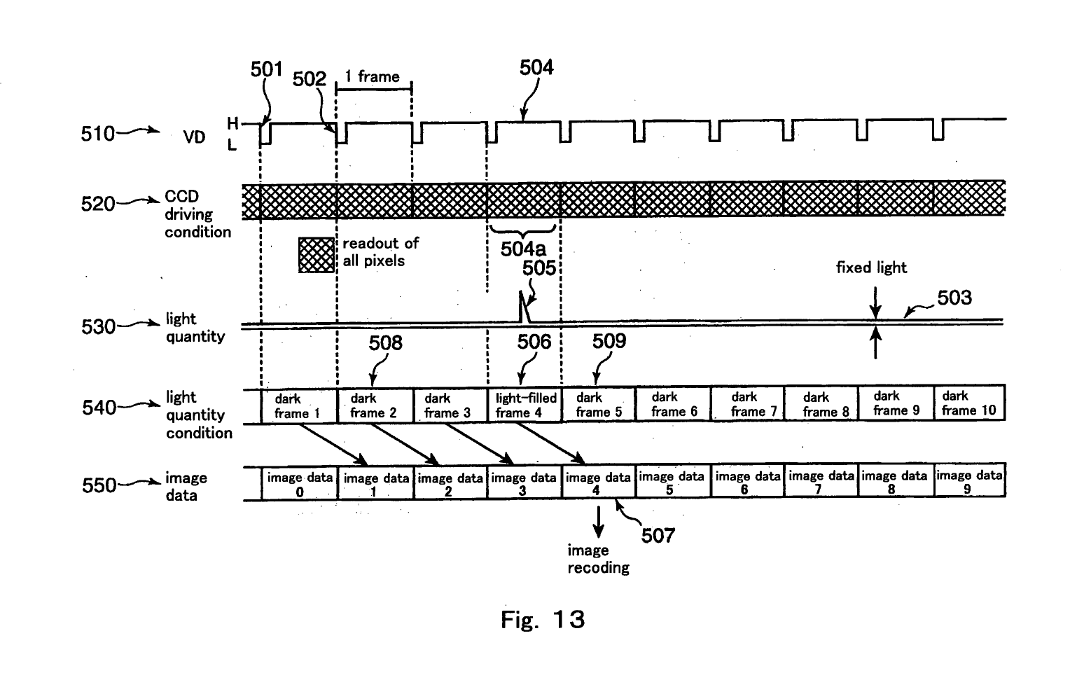

FIG. 13 is a view for explaining an operation of image data readout from the image sensor 21 in shooting when the metering portion (the metering portion 11) is not provided in the image capturing apparatus (the mobile telephone 1a) and the external flash light is detected based on the image data held in the digital processor. The image data readout operation in the image capturing apparatus not having the metering portion is similar in a fourth embodiment described later. In FIG. 13, reference numeral 510 represents a vertical synchronization signal (pulse signal) for the image sensor 21 like the VD signal. Reference numeral 520 is a view explaining the driving condition when image data is read out in the image sensor 21. Reference numeral 530 is a view showing fluctuations in the quantity of extraneous light of the mobile telephone la in dark places. Reference numeral 540 is a view for explaining the light quantity condition for each frame corresponding to the VD signal. Reference numeral 550 is a view showing the image data corresponding to each frame shown at reference numeral 540.

At a falling point 501 when the level of the VD signal becomes from high “H” to low “L,” the exposure of the image sensor 21 (CCD) is started. Then, at the next falling point 502, the readout of the shot image data by the exposure from the image sensor 21 is started, and the next exposure operation is started. In this manner, the exposure and image readout operations on the image sensor 21 are repeated with the section shown by the falling points 501 and 502 as one period while vertically synchronized by the VD signal. The above-mentioned one period corresponds to an image of one frame in the shot image captured from the image sensor 21, and the time of the one period is approximately 1/30 second.

As described above, in a predetermined period based on the VD signal (for each frame), the readout of all the pixels (entire image data) of the shot image by the image sensor 21 is performed all the time as shown in the view of reference numeral 520. This corresponds to the capturing readout being performed from the image sensor 21 all the time (every period). The image data being read out is transmitted up to the digital processor 24a by way of the analog processor 22a and the A/D converter 23 and held thereby. The main controller 30a (the flash detector 302a) detects, for example, the quantity of fixed light (extraneous light) shown at reference numeral 503 all the time based on the image data held by the digital processor 24a. Under a condition where the light quantity is thus detected, when the external flash light is emitted as shown at reference numeral 505, for example, in the period of reference numeral 504 (reference numeral 504a shown in the view of reference numeral 520) of the VD signal, the main controller 30a detects the quantity of external flash light, and when determining that the light quantity has reached a predetermined threshold value to become an external flash shooting possible level, the entire image data (entire image data including the image data before the external flash light is emitted in the shooting possible frame shown at reference numeral 506) in the frame exposed by the external flash light (the shooting possible frame 506) is identified as the flash image obtaining exposure sufficient for shooting. Then, the identified image data (image data shown at reference numeral 507) undergoes image processings such as the gain changing processing to reduce the gain at the digital processor 24a, and then, is recorded onto the recording portion 25. The flash image may be temporarily (not necessarily temporarily) monitor-displayed on the display portion 26, for example, for the confirmation of the shot image (in this case, image processing such as the gain changing processing for monitor display is performed on the flash image).

On the other hand, the image data, for example, in the frame exposed by fixed light as shown at reference numeral 503 (for example, light quantity insufficient frames shown at reference numerals 508 and 509) other than the image data when the external flash light is emitted is in an exposure condition where the light quantity is insufficient. This image data undergoes image processings such as the gain changing processing to increase the gain at the digital processor 24a in order to correct the insufficiency of the gain in the display on the display portion 26, and then, is successively live-view-displayed on the display portion 26. The shot image with insufficient light quantity is not necessarily live-view-displayed, and in this case, it is unnecessary to perform image processings such as the gain changing processing on the image data. The image data is stored in the memory of the digital processor 24a at least until it is determined whether the image data is suitable or unsuitable as the image for capturing. In this case, a plurality of frame images may be stored or the frame image may be stored while being updated (rewritten) every time the next frame image is captured (from this viewpoint, it is said that a dark frame image with insufficient light quantity is discarded without recorded onto the recording portion 25).

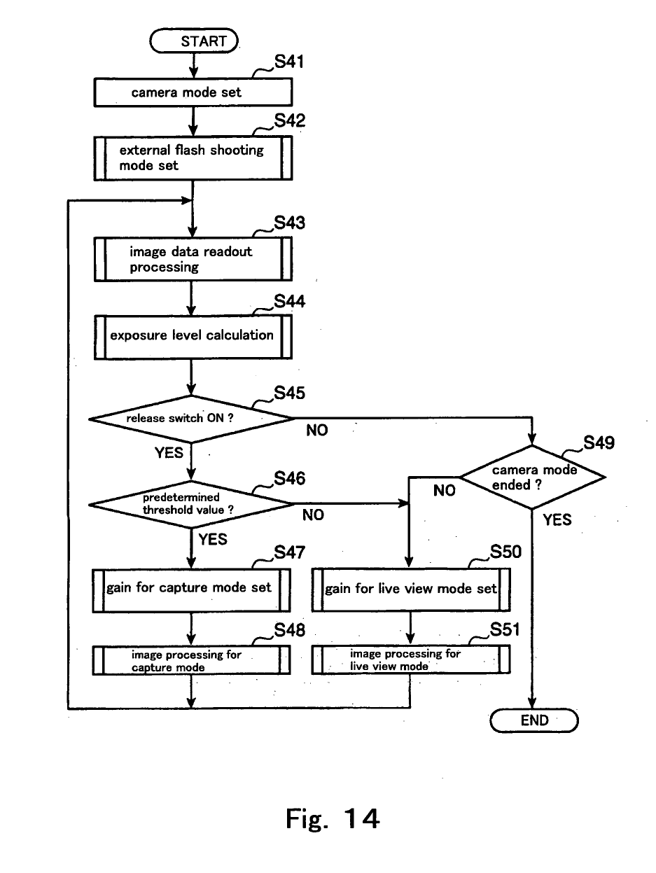

FIG. 14 is a flowchart showing an example of the shooting operations in the external flash shooting mode according to the third embodiment. First, the mode setting switch 5 is operated and the camera mode to perform shooting by use of the camera function of the mobile telephone 1a is set in the mode setter 301 to bring the mobile telephone 1a in a camera shooting possible condition (step S41), and the external flash shooting mode is set (step S42). Then, all pixel readout (capturing readout) of the frame image data from the image sensor 21 is performed in synchronism with the VD signal, the frame image is stored (held) in the digital processor 24a (step S43), and based on the image data being held, the exposure level of the image sensor, that is, the quantity of extraneous light is calculated (detected) by the flash detector 302a (step S44). The image data read out at step S43 may undergo the gain changing processing to increase the gain or the like and be live-view-displayed as the live view image.

When the release switch 6 is not turned on (NO of step S45) and the camera mode set at step S41 is not ended (canceled) (NO of step S49) in the external flash shooting mode, the gain (digital gain) for live view is set in the digital processor 24a (step S50). Then, an image processing to change the gain to the gain for live view is performed on the live view image (one frame) captured from the image sensor 21 (other digital signal processings are also performed), and the live view image is displayed on the LCD display 8 (step S51). When the operation of step S51 is finished, the process returns to step S43, and thereafter, while the release switch 6 is not turned on and the camera mode is not ended, the operations of steps S43, S44, S50 and S51 are repeated to perform live view display. When the camera mode set at step S41 is ended (canceled) (YES of step S49), the flow is ended.

In a case where the release switch 6 is turned on at step S45 (YES of step S45), when it is not determined by the light quantity determiner 303 that the light quantity detected by the flash detector 302 has reached the predetermined threshold value, that is, when it is determined that the frame image is insufficient in light quantity (NO of step S46), the operations of steps S50 and S51 are performed to perform live view display. That is, even if the release switch 6 is turned on at step S45, unless the external flash light has reached the predetermined light quantity at step S46, the live view display by steps S43, S44, S50 and S51 is continued.

When it is determined by the light quantity determiner 303 that the light quantity has reached the predetermined threshold value at step S46 (YES of step S46), the gain for capturing (low gain) is set in the digital processor 24a (step S47), various image processings for capturing such as the change of the gain to the gain for capturing, the white balance correction, the color interpolation and the generation of signals for display are performed on the image data held in the digital processor 24a, and the image having undergone the image processings is recorded onto the recording portion 25 as the captured image (step S48). The captured image may be temporarily (not necessarily temporarily) monitor-displayed on the LCD display 8 as well as recorded onto the recording portion 25. When the operation of step S48 is finished, the process returns to step S43. When the external flash shooting mode is not set at step S42, shooting can be performed irrespective of the external flash light. In this case, for example, when the camera mode is set at step S41, the mode is immediately shifted to the live view mode to perform live view display (live view display is not necessarily performed), and then, in response to the turning on of the release switch 6, normal shooting (recording of the shot image) is performed.

### Fourth Embodiment

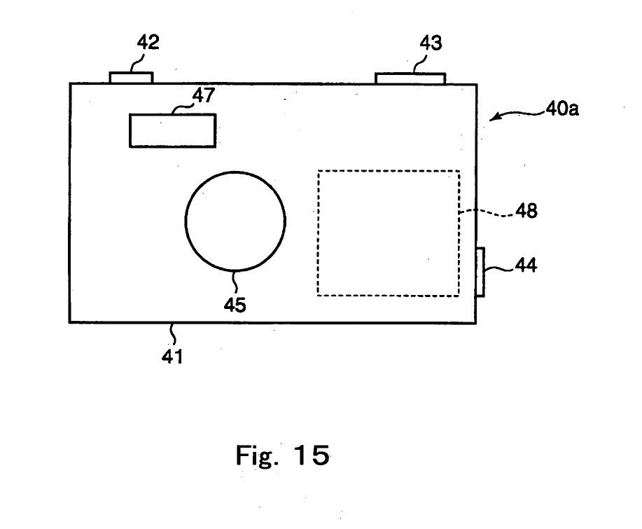

FIG. 15 is a schematic front view showing the appearance of a digital camera as an image capturing apparatus according to a fourth embodiment of the present invention. The digital camera 40a shown in FIG. 15 is different from the digital camera 40 shown in FIG. 6 in that the metering portion 46 (on the front surface) is not provided. The structures of other portions are the same as those of the digital camera 40 shown in FIG. 6, and descriptions thereof are omitted.

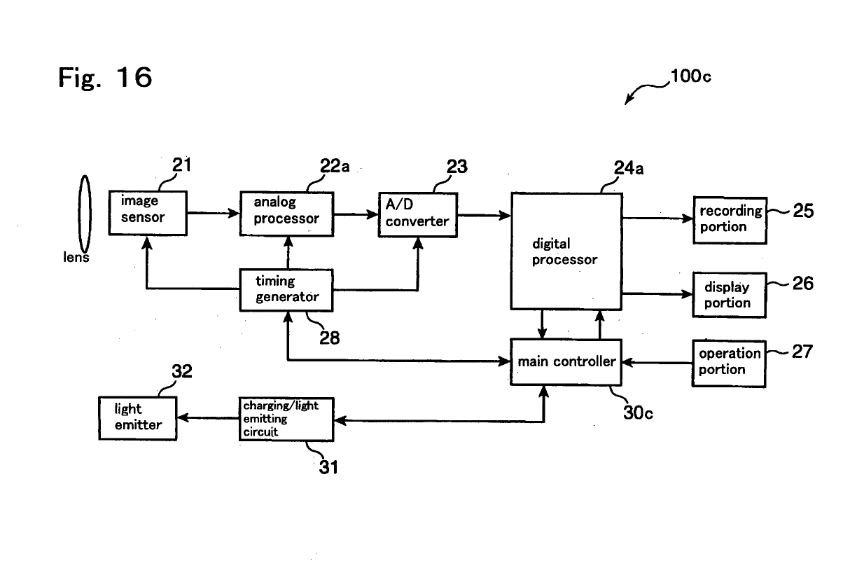

FIG. 16 is a block diagram showing an example of a camera control system of the digital camera 40a shown in FIG. 15. The camera control system 100c shown in FIG. 16 is different from the camera control system 10a shown in FIG. 7 in that the light quantity detector 29 is not provided in the system and that based on the image data captured from the image sensor 21 to the digital processor 24a, the detection of the external flash light, the gain changing processing on the image data and the like are performed.

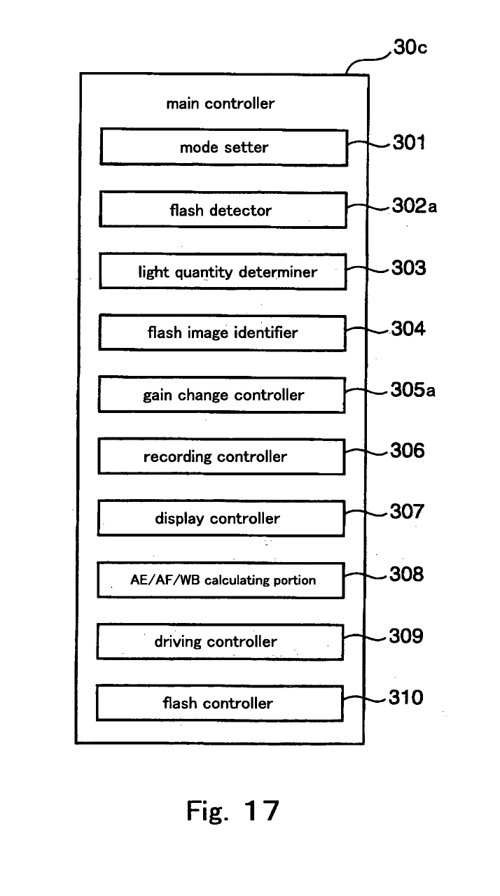

With respect to the differences other than the presence or absence of the light quantity detector 29, the structures of the analog processor 22a, the digital processor 24a and the main controller 30c and the structures of the analog processor 22, the digital processor 24 and the main controller 30a are different between FIG. 16 and FIG. 7. The structures of the analog processor 22a and the digital processor 24a shown in FIG. 16 are the same as the structures of the analog processor 22a and the digital processor 24a shown in FIG. 11 (the differences in structure from FIG. 7 are described above). Moreover, with respect to the main controller 30c, as shown in the functional block diagram of FIG. 17, the structures of the flash detector 302a and the gain change controller 305a of the main controller 30c are the same as the structures of the flash detector 302a and the gain change controller 305a of the main controller 30b shown in FIG. 12 (the differences in structure from FIG. 8 are described above), the structure of the flash controller 310 of the main controller 30c is the same as the structure of the flash controller 310 shown in FIG. 8 (the differences in structure from FIG. 3 are described above), and descriptions thereof are omitted.

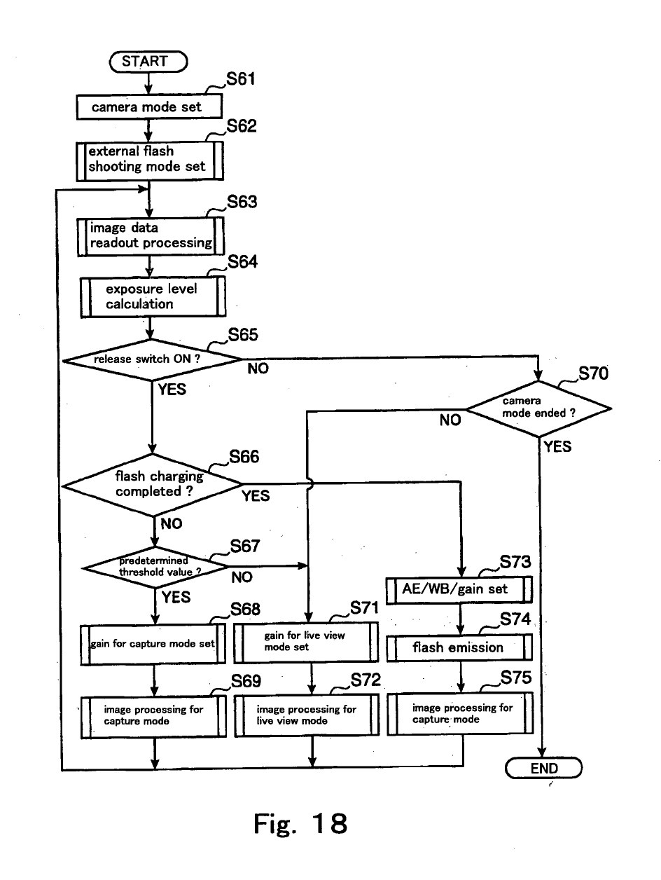

FIG. 18 is a flowchart showing an example of the shooting operations in the external flash shooting mode according to the fourth embodiment. First, the power switch 44 is turned on to bring the digital camera 40a in a camera shooting possible condition (camera mode) (step S61), and the mode setting switch 43 is operated to set the external flash shooting mode in the mode setter 301 (step S62). Then, all pixel readout (capturing readout) of the frame image data from the image sensor 21 is performed in synchronism with the VD signal, the frame image is stored (held) in the digital processor 24a (step S63), and based on the image data being held, the exposure level of the image sensor, that is, the quantity of extraneous light is calculated (detected) by the flash detector 302a (step S64). The image data read out at step S63 may undergo the gain changing processing to increase the gain or the like and be live-view-displayed as the live view image.

When the release switch 42 is not turned on (NO of step S65) and the camera mode set at step S61 is not ended (canceled) (No of step S70) in the external flash shooting mode, the gain (digital gain) for live view is set in the digital processor 24a (step S71). Then, an image processing to change the gain to the gain for live view is performed on the live view image (one frame) captured from the image sensor 21 (other digital signal processings are also performed), and the live view image is displayed on the LCD display 48 (step S72). When the operation of step S72 is finished, the process returns to step S63, and thereafter, while the release switch 42 is not turned on and the camera mode is not ended, the operations of steps S63, S64, S71 and S72 are repeated to perform live view display. When the camera mode set at step S61 is ended (canceled) (YES of step S70), the flow is ended.

In a case where the release switch 42 is turned on at step S65 (YES of step S65), when it is determined by the flash controller 310 that the flash charging is not completed (NO of step S66), in a case where it is not determined by the light quantity determiner 303 that the light quantity detected by the flash detector 302a has reached the predetermined threshold value, that is, in a case where it is determined that the frame image is insufficient in light quantity (NO of step S67), the operations of steps S71 and S72 are performed to perform live view display. That is, even if the release switch 42 is turned on at step S65, when the flash charging is not completed at step S66 and the external flash light has not reached the predetermined light quantity at step S67, the live view display by steps S63, S64, S71 and S72 is continued.

When it is determined by the light quantity determiner 303 that the light quantity has reached the predetermined threshold value at step S67 (YES of step S67), the gain for capturing (low gain) is set in the digital processor 24a (step S68), various image processings for capturing such as the change of the gain to the gain for capturing, the white balance correction, the color interpolation and the generation of signals for display are performed on the image data held in the digital processor 24a, and the image having undergone the image processings is recorded onto the recording portion 25 as the captured image (step S69). The captured image may be temporarily (not necessarily temporarily) monitor-displayed on the LCD display 48 as well as recorded onto the recording portion 25. When the operation of step S69 is finished, the process returns to step S63. As described above, since the flow of steps S67 to S69 is provided and shooting can be performed by use of another light source (external flash light) even when the flash charging is not completed, the waiting time of shooting to the completion of the charging (the time lag to shooting) can be reduced.

On the other hand, when the flash charging is completed at step S66 (YES of step S66), through the control by the flash controller 310, various settings are made such as the appropriate exposure, white balance and gain corresponding to flash shooting by the light emission (self-emission) of the flash light 47 (step S73). Then, in accordance with the settings, the flash light 47 performs flash light emission not in synchronism with the image (shooting by the VD signal) (step S74), the capturing readout of the image data from the image sensor 21 is performed like at step S69, various image processings are performed on the captured image being read out, and then, the captured image is recorded onto the recording portion 25 (step S75). In this case, the captured image may also be monitor-displayed on the LCD display 48 as well as recorded onto the recording portion 25. When the operation of step S75 is finished, the process returns to step S63. When the external flash shooting mode is not set at step S62, shooting can be performed irrespective of the external flash light. In this case, normal shooting is performed in response to the turning on of the release switch 42 (flash shooting by the light emission of the flash light 47 may be performed). In the normal shooting, live view display may be performed as appropriate.

As described above, by the image capturing apparatus according to the present invention, the external flash light except the flash light by self-emission is detected by the flash detector 302 (302a), and the light quantity determiner 303 determines whether the quantity of external flash light detected by the flash detector 302 (302a) has reached the predetermined threshold value or not. Then, when the image exposed by the external flash light in the shot image obtained by the image sensor 21 is identified as the flash image by the flash image identifier 304 and it is determined by the light quantity determiner 303 that the quantity of external flash light has reached the threshold value, the flash image identified by the flash image identifier 304 is recorded onto the recoding portion 25 (the recording controller 306). As described above, since the flash image exposed by the external flash light having a predetermined light quantity is recorded (captured as the captured image) in response to the reception of the external flash light, even in the case of an image capturing apparatus having no flash function or even while the flash is being charged although the flash function is provided, a favorable (high-image-quality, beautiful) shot image having a sufficient exposure amount (exposure) can be obtained in dark places, and consequently, an image capturing apparatus can be provided with which opportunities for shooting can be increased.

Moreover, since the flash image is recorded by the recording portion 25 under a condition where the gain is changed by the analog processor 22 (22a) or the digital processor 24 (24a) so that the gain for the flash image is lower than the gain for the image other than the flash image in the shot image, by a simple method, the flash image can be recorded (as a beautiful image) while the exposure condition is made appropriate and the S/N ratio is reduced, so that a more favorable (high-image-quality, beautiful) shot image can be obtained.

Moreover, since the metering of the subject is performed by the light quantity detector 29 (the metering portion 11 or 46) provided in the image capturing apparatus and the detection of the external flash light is performed based on the obtained metering information, for example, an operation is unnecessary such as temporarily capturing the image data in a data processor (for example, the digital processor 24 (24a)) as digital data and performing the detection of the external flash light by use of the image data, so that the detection of the external flash light can be performed more directly, consequently, reliably. Moreover, since metering information on the detection of the external flash light can be obtained separately from the operation to capture the image data (by another system, circuit), for example, it can be easily performed to obtain a more favorable shot image (flash image) by feeding back the metering information (changing the gain) in the analog processing with an excellent S/N ratio before the image data is captured as the digital data.

Moreover, since the external flash light is detected by the flash detector 302a based on the image data of the shot image obtained by the image sensor 21, it is unnecessary to separately provide metering means (for example, the metering portion 11 or 46) for detecting the (quantity of) external flash light and this enables size reduction of the apparatus, and with a simple structure using an existing apparatus, the detection of the external flash light can be performed.

Moreover, since the image processing to change the gain is performed by the digital processor 24a in the digital processing performed after the analog-to-digital conversion is performed, that is, since the image processing to change the gain is performed on the image data after the image data is captured in the digital processor 24a as digital data, the gain can be changed to a given value at a given time, for example, the image data is captured with the gain as approximately once and later, the gain is changed to a predetermined multiple. Consequently, the image processing can be performed with a high degree of freedom.

Moreover, since the image processing to change the gain is performed by the analog processor 22 in the analog processing performed before the analog-to-digital conversion, the image processing can be more accurately performed with an excellent S/N ratio.

Moreover, since the image capturing apparatus (the mobile telephones 1 and 1a) is not provided with a flash light emitter that emits flash light by self-emission, the apparatus can be made simple accordingly, so that cost can be reduced.

Moreover, since the image capturing apparatus (the digital cameras 40 and 40a) is provided with the flash light 47 (the light emitter 32) that emits flash light by self-emission and even when it is determined by the flash controller 310 that the charging of the flash light 47 for performing self-emission is not completed, a flash image having received the external flash light is recorded by the recording portion 25, the flash image can be obtained (recorded) by use of flash light by the self-emission of the flash light 47 with no dependence on the external flash light, and even when the flash controller 310 is provided, whether the flash light 47 is being charged or not can be determined and it is determined that the flash light 47 is being charged, the recording of the flash image by the external flash light can be performed. Consequently, higher priority can be given to a good opportunity to take a picture than to waiting until the completion of the charging and causing the flash light to perform self-emission, and opportunities to perform shooting that requires flash light (flash light by self-emission or external flash light) in dark places and the like can be further increased.

Moreover, in the image capturing apparatus (the mobile telephones 1 and la and the digital cameras 40 and 40a) not having synchronizing means (a predetermined synchronizer, a synchronizing circuit) that causes a predetermined flash light emitter outside the apparatus to emit flash light, the external flash light except the flash light by the light emission from the apparatus is detected by the flash detector 302 based on the metering information using the metering portion 11 (46), and whether the quantity of external flash light detected by the flash detector 302 has reached the predetermined threshold value or not is determined by the light quantity determiner 303. When the image exposed by the external flash light in the shot image obtained by the image sensor 21 is identified as the flash image by the flash image identifier 304 and it is determined by the light quantity determiner 303 that the quantity of external flash light has reached the threshold value, the flash image identified by the flash image identifier 304 is recorded onto the recoding portion 25. As described above, since the flash image exposed by the flash light is recorded (captured as the captured image) in response to the detection, based on the metering information by the metering portion 11 (46), of the external flash light not by the flash light by so-called “self-emission” including not only a case where flash light emission is performed by use of the flash light 47 of the apparatus but also a case where flash light emission is performed with a predetermined flash emitter outside the apparatus being synchronized (external synchronization), even in the case of an image capturing apparatus having no flash function or even while the flash is being charged although the flash function is provided, a favorable (high-image-quality, beautiful) shot image having a sufficient exposure amount can be obtained in dark places, and consequently, an image capturing apparatus can be provided with which opportunities for shooting can be increased.

Further, in the image capturing apparatus not having synchronizing means (a predetermined synchronizer, a synchronizing circuit) that causes a predetermined flash light emitter outside the apparatus to emit flash light, the external flash light except the flash light by the light emission from the apparatus is detected by the flash detector 302a based on the image data of the shot image obtained by the image sensor 21, and whether the quantity of external flash light detected by the flash detector 302a has reached the predetermined threshold value or not is determined by the light quantity determiner 303. When the image exposed by the external flash light in the shot image obtained by the image sensor 21 is identified as the flash image by the flash image identifier 304 and it is determined by the light quantity determiner 303 that the quantity of external flash light has reached the threshold value, the flash image identified by the flash image identifier 304 is recorded onto the recoding portion 25. As described above, since the flash image exposed by the external flash light is recorded (captured as the so-called captured image) in response to the detection, based on the image data from the image sensor 21 (held in the digital processor 24a), of the external flash light not by the flash light by so-called “self-emission” including not only a case where flash light emission is performed by use of a flash light emitter of the apparatus but also a case where flash light emission is performed with a flash emitter outside the apparatus being synchronized (external synchronization), even in the case of an image capturing apparatus having no flash function or even while the flash is being charged although the flash function is provided, a favorable (high-image-quality, beautiful) shot image having a sufficient exposure amount can be obtained in dark places, and consequently, an image capturing apparatus can be provided with which opportunities for shooting can be increased.

The present invention can take the following modes:

(A) The mobile telephone 1 (1a) may be provided with a flash light emitter. Moreover, the digital camera 40 (40a) may have no flash light emitter. The mobile telephone 1 (1a) or the digital camera 40 (40a) may have no AF function, AE function or mechanical shutter.

(B) The following structure may be adopted: The image sensor 21 comprises an image sensor capable of so-called nondestructive reading to read out the accumulated charges without destructing them, for example, a CMOS (complementary metal-oxide semiconductor) and the image sensor 21 comprising a CMOS is used, for example, instead of the light quantity detector 29 shown in FIG. 2 (how much light impinges on the image sensor at present can be directly monitored from the CMOS without the image data being destructed). According to this structure, it is unnecessary to provide the light quantity detector 29 (the metering portion 11), so that the apparatus can be simplified.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. An image capturing apparatus comprising:
image sensor which obtains an image of an object;
detector configured to detect external flash light except flash light by self-emission;
determiner configured to determine whether a quantity of external flash light detected by the detector has reached a predetermined threshold value;
identifier configured to identify, as a flash image, an image exposed by the external flash light among the images obtained by the image sensor; and
recording portion which receives the flash image identified by the identifier to record when the determiner determines that the quantity of external flash light has reached the threshold value.

2. An image capturing apparatus as claimed in claim 1, further comprising:
image processor configured to perform an image processing to change a gain for the image obtained by the image sensor; and
wherein said recording portion records the flash image under a condition where the gain is changed by the image processor, so that the gain for the flash image identified by the identifier is lower than a gain for an image other than the flash image obtained by the image sensor.

3. An image capturing apparatus as claimed in claim 1, further comprising:
metering portion configured to measure a light quantity of the object; and
wherein said detector detects the external flash light based on metering information from the metering portion.

4. An image capturing apparatus as claimed in claim 1, wherein said detector detects the external flash light based on image information of the image obtained by the image sensor.

5. An image capturing apparatus as claimed in claim 2, wherein said image processor changes the gain in a digital processing following analog-to-digital conversion.

6. An image capturing apparatus as claimed in claim 2, wherein the image processor changes the gain in an analog processing before analog-to-digital conversion.

7. An image capturing apparatus as claimed in claim 1, wherein the image capturing apparatus is not provided with flash light emitter for emitting flash light by self-emission.

8. An image capturing apparatus as claimed in claim 1, further comprising:
flash light emitter which emits flash light by self-emission; and
flash controller configured to determine whether charging of the flash light emitter is completed; and
wherein said recording portion receives the flash image identified by the identifier to record when the flash controller determines that the charging of the flash light emitter is not completed.

9. An image capturing apparatus as claimed in claim 1, wherein the image capturing apparatus includes a mobile telephone or a digital camera.

10. An image capturing apparatus as claimed in claim 1, wherein said image sensor includes a charge-coupled device or a complementary metal-oxide semiconductor.

11. An image capturing apparatus without synchronizer which causes flash light emitter provided outside the apparatus to emit flash light, said image capturing apparatus comprising:
image sensor which obtains an image of an object;
metering portion configured to measure a light quantity of the object;
detector configured to detects external flash light except flash light by light emission from the apparatus based on metering information by the metering portion;
determiner configured to determine whether a quantity of external flash light detected by the detector has reached a predetermined threshold value;
identifier configured to identify, as a flash image, an image exposed by the external flash light in the image obtained by the image sensor; and
recording portion which receives the flash image identified by the identifier to record when the determiner determines that the quantity of external flash light has reached the threshold value.

12. An image capturing apparatus without synchronizer which causes flash light emitter provided outside the apparatus to emit flash, said image capturing apparatus comprising:
image sensor which obtains an image of an object;
detector configured to detect external flash light except flash light by light emission from the apparatus based on image information of the image obtained by the image sensor;
determiner configured to determine whether a quantity of external flash light detected by the detector has reached a predetermined threshold value;
identifier configured to identify, as a flash image, an image exposed by the external flash light in the image obtained by the image sensor; and
recording portion which receives the flash image identified by the identifier to record when it the determiner determines that the quantity of external flash light has reached the threshold value.

13. A program product which is readable by a computer of a controller in an image capturing apparatus, said program product performing the following steps of:
obtaining an image of an object;
detecting external flash light except flash light by self-emission;
determining whether a quantity of external flash light detected has reached a predetermined threshold value;
identifying, as a flash image, an image exposed by the external flash light among the images obtained by the image sensor; and
receiving the flash image identified to record when it is determined that the quantity of external flash light has reached the threshold value.
